(19) United States
(12) Patent Application Publication
(10) Pub. No.: US 2018/0285698 A1
(43) Pub. Date: Oct. 4, 2018

(54) IMAGE PROCESSING APPARATUS, IMAGE PROCESSING METHOD, AND IMAGE PROCESSING PROGRAM MEDIUM

(71) Applicant: FUJITSU LIMITED, Kawasaki-shi (JP)

(72) Inventor: Goro Yamada, Adachi (JP)

(73) Assignee: FUJITSU LIMITED, Kawasaki-shi (JP)

(21) Appl. No.: 15/921,779

(22) Filed: Mar. 15, 2018

(30) Foreign Application Priority Data
Mar. 31, 2017 (JP) 2017-071447

(51) Int. Cl. G06K 9/66; G06K 9/46; G06K 9/62

(52) U.S. Cl. CPC G06K 9/66; G06K 9/6264; G06K 9/4676

(57) ABSTRACT

An image processing method for an image recognition using teacher data of a recognition target, the method including: designating a mask designation area which is at least a part of a portion other than a specific characteristic portion in an image of the teacher data of the recognition target; and generating masked teacher data by masking the designated mask designation area of the teacher data of the recognition target, so that variety of teacher data can be increased without any unwilling bias or deviation.

### CROSS-REFERENCE TO RELATED APPLICATION

This application is based upon and claims the benefit of priority of the prior Japanese Patent Application No. 2017-71447, filed on Mar. 31, 2017, the entire contents of which are incorporated herein by reference.

### FIELD

The embodiments discussed herein are related to an image processing apparatus, an image processing method, and an image processing program medium.

### BACKGROUND

Today, among machine learning methods in an artificial intelligence field, deep learning has achieved remarkable outcome particularly in the field of image recognition. However, putting deep learning into practical use for any purposes including image recognition has a problem in that the deep learning has to use a large quantity of teacher data (also known as training data) in various variations. In most cases, collecting a large quantity of such teacher data is practically difficult in terms of time, costs, and procedures related to copyrights. When the teacher data is insufficient, learning may not be satisfactorily performed, leading to poor recognition accuracy.

To address this, there has been proposed a method of detecting an obstacle for a crane (see Japanese Laid-open Patent Publication No. 2016-13887, for example). Specifically, in order to reduce wrong recognition, an image of the surrounding area of the crane to be monitored is displayed with a portion including the crane masked. Further, there has been proposed a method for image recognition by using a camera (see Japanese Laid-open Patent Publication No. 2007-156693, for example). This method reduces wrong recognition in an image captured by the camera by preparing a mask pattern for a non-target image and masking the non-target image in the image captured by the camera.

However, the cited documents do not intend to: increase variations of teacher data with a non-target characteristic portion in each image of teacher data masked, the portion being a characteristic portion relating to only this image, and being a portion which is other than a specific characteristic portion in the image and is desired to be excluded from the learning; and generate the teacher data in the variations which are less biased (there are less duplications or deviations in the variations).

Even when the variations of the teacher data are increased, the biased (duplicated) variations cause portions other than the specific characteristic portion of the teacher data to be learnt by deep learning, taking long processing time and possibly lowering the recognition rate. For example, in learning two types of automobile images, the presence or absence of a passenger may be learnt as a characteristic if there are only teacher data in which a passenger is seen across a windshield and teacher data in which a passenger is not seen.

An object of one aspect of the disclosure is to provide an image processing apparatus, an image processing method, an image processing program, and a teacher data generation method that may reduce learning of a portion other than a specific characteristic portion in an image of teacher data, and efficiently improve the recognition rate.

### SUMMARY

According to an aspect of the invention, in an image processing method for an image recognition using teacher data of a recognition target, the method including: designating a mask designation area which is at least a part of a portion other than a specific characteristic portion in an image of the teacher data of the recognition target; and generating masked teacher data by masking the designated mask designation area of the teacher data of the recognition target, so that variety of teacher data can be increased without any unwilling bias or deviation.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a block diagram illustrating an example of hardware configuration of an entire image processing apparatus;

FIG. 2 is a block diagram illustrating an example of the entire image processing apparatus;

FIG. 3 is a flow chart illustrating an example of the flow of processing of the entire image processing apparatus;

FIG. 4 is a block diagram illustrating an example of the entire image processing apparatus including a designation unit and a teacher data generation unit;

FIG. 5 is a flow chart illustrating an example of the flow of processing of the entire image processing apparatus including the designation unit and the teacher data generation unit;

FIG. 6 is a block diagram illustrating an example of the designation unit and the teacher data generation unit;

FIG. 7 is a flow chart illustrating an example of the flow of processing of the designation unit and the teacher data generation unit;

FIG. 8 is a block diagram illustrating an example of a masking processing unit;

FIG. 9 is a flow chart illustrating an example of the flow of processing of the masking processing unit;

FIG. 10 is a block diagram illustrating an example of an entire learning unit;

FIG. 11 is a block diagram illustrating another example of the entire learning unit;

FIG. 12 is a flow chart illustrating an example of the flow of processing of the entire learning unit;

FIG. 13 is a block diagram illustrating an example of an entire inference unit;

FIG. 14 is a block diagram illustrating another example of the entire inference unit;

FIG. 15 is a flow chart illustrating an example of the flow of processing of the entire inference unit;

FIG. 16 is a block diagram illustrating an example of an entire image processing apparatus in Embodiment 3;

FIG. 17 is a flow chart illustrating an example of the flow of processing of the entire image processing apparatus in Embodiment 3;

FIG. 18 is a block diagram illustrating an example of a masking learning unit of the image processing apparatus in Embodiment 3;

FIG. 19 is a block diagram illustrating an example of an automatic masking unit of the image processing apparatus in Embodiment 3;

FIG. 20 is a block diagram illustrating an example of an entire inference unit in Embodiment 3;

FIG. 21 is a block diagram illustrating an example of a test data generation unit in Embodiment 3;

FIG. 22 is a block diagram illustrating an example of the flow of processing of the test data generation unit in Embodiment 3;

FIG. 23 is a block diagram illustrating an example of an entire inference unit in Embodiment 5; and

FIG. 24 is a flow chart illustrating the flow of processing of the entire inference unit in Embodiment 5.

### DESCRIPTION OF EMBODIMENTS

Hereinafter, embodiments will be described, but the disclosure is not limited to these embodiments. Since control performed by a designation unit, a teacher data generation unit and others in an “image processing apparatus” of the disclosure corresponds to implementation of an “image processing method” of the disclosure, details of the “image processing method” become apparent from description of the “image processing apparatus” of the disclosure. Further, since an “image processing program” of the disclosure is realized as the “image processing apparatus” of the disclosure by using a computer or the like as a hardware resource, details of the “image processing program” of the disclosure become apparent from description of the “image processing apparatus” of the disclosure. Since control performed by a designation unit and a teacher data generation unit in a “teacher data generation apparatus” corresponds to implementation of a “teacher data generation method” of the disclosure, details of the “teacher data generation method” become apparent from the “teacher data generation apparatus”. Further, since a “teacher data generation program” is realized as the “teacher data generation apparatus” by using a computer or the like as a hardware resource, details of the “teacher data generation program” become apparent from description of the “teacher data generation apparatus”.

The image processing apparatus of the disclosure is an apparatus that performs image recognition using teacher data of a recognition target, and the image recognition is preferably performed by deep learning. Preferably, the image processing apparatus includes a designation unit that designates a non-target characteristic portion in an image of the teacher data of the recognition target, that is, a characteristic portion relating to only this image, or at least a part of a portion which is other than a specific characteristic portion in the image, and is desired to be excluded from the learning, and a teacher data generation unit that masks the designated part of the portion other than specific characteristic portion to generate masked teacher data of the recognition target, and further includes a learning unit and an inference unit.

Preferably, masking of the portion other than the specific characteristic portion is performed before learning or inference. Learning is performed using the masked teacher data generated by the teacher data generation unit, and inference is performed using the masked test data generated by the test data generation unit. Preferably, a plurality of portions other than the specific characteristic portion are masked, the teacher data generation unit further generates masked teacher data in which at least one of the masks is removed. Preferably, a plurality of portions other than the specific characteristic portion are masked, the test data generation unit further generates masked test data in which at least one of the masks is removed.

The portion other than the specific characteristic portion is a portion other than a portion based on which a recognition target can be recognized, and varies according to the recognition target. The portion other than the specific characteristic portion may be absent in the image of the teacher data of the recognition target, and one or more portions other than the specific characteristic portion may be present.

The method of distinguishing the portion other than the specific characteristic portion (the method of obtaining the characteristic amount of the characteristic portion) is not specifically limited, and may be appropriately selected according to intended use, for example, by using scale-invariant feature transform (SIFT), speed-upped robust feature (SURF), rotation-invariant fast feature (RIFF), or histograms of oriented gradients (HOG).

The portion other than the specific characteristic portion may not be unconditionally specified since it varies depending on the recognition target, but is a non-target characteristic portion desired to be excluded from the learning. For example, in classifying automobiles, portions other than the specific characteristic portion include a number plate with unique numerical characters, a windshield through which a passenger may be seen, and a headlight that varies in reflection depending on the automobile.

In classifying an animal, portions other than the specific characteristic portion includes a collar and a tag. The collar and the tag may be wrongly learnt as characteristics according to whether or not the animal is a pet.

In classifying clothes, portions other than the specific characteristic portion include a person and a mannequin. In a photograph of a person or mannequin wearing clothes, the person or mannequin may be wrongly recognized as a characteristic.

In the masked teacher data of the recognition target, the non-target characteristic portion in the image of the teacher data of the recognition target, that is, the characteristic portion relating to only this image, the characteristic portion being at least a part of a portion other than the specific characteristic portion, which is desired to be excluded from the learning, is masked. The whole or a part of the portion other than the specific characteristic portion may be masked. When a plurality of portions other than the specific characteristic portion are present, at least one of the portions other than the specific characteristic portion may be masked, or all of the portions other than the specific characteristic portion may be masked.

The recognition target refers to a target to be recognized (classified). The recognition target is not specifically limited, and may be appropriately selected according to intended use. Examples of the recognition target include various images of human's face, bird, dog, cat, monkey, strawberry, apple, steam train, train, automobile (bus, truck, family car), ship, airplane, figures, characters, and objects that are viewable to human.

The teacher data refers to a pair of “input data” and “correct label” that is used in supervised deep learning. Deep learning is performed by inputting the “input data” to a neural network having a lot of parameters to update a difference between an inference label and the correct label (weight during learning) and find a learnt weight. Thus, the mode of the teacher data depends on an issue to be learnt (thereinafter the issue may be referred to as “task”). Some examples of the teacher data are illustrated in a following table 1.

TABLE 1

| Task | Input | Output |
|---|---|---|
| Classify animal in image | Image | Class (also referred to |
| | | label) |
| Detect area of automobile in image | Image | Image set (output image of |
| in unit of pixels | | 1ch for object) |
| Determine whose voice it is | Voice | Class |

Deep learning is one kind of machine learning using a multi-layered neural network (deep neural network) mimicking the human's brain, and may automatically learn characteristics of data.

The image recognition technology serves to analyze contents of image data, and recognize the shape. According to the image recognition technology, the outline of a target is extracted from the image data, separates the target from background, and analyzes what the target is. Examples of technique utilizing image recognition technology include optical character recognition (OCR), face recognition, and iris recognition. According to the image recognition technology, a kind of pattern is taken from image data that is a collection of pixels, and meaning is read off the pattern. Analyzing the pattern to extract meaning of the target is referred to as pattern recognition. Pattern recognition is used for image recognition as well as speech recognition and language recognition.

The following embodiments specifically describe an “image processing apparatus” of the disclosure, but the disclosure is not limited to the embodiments.

### Embodiment 1

An image processing apparatus in Embodiment 1 will be described below. The image processing apparatus functions to recognize an image using teacher data of a recognition target.

Embodiment 1 describes an example of an image processing apparatus including a designation unit and a teacher data generation unit for masking a non-target characteristic portion, that is, a characteristic portion relating to only this image, the characteristic portion being a portion which is other than a specific characteristic portion and is desired to be excluded from the learning, by the operator.

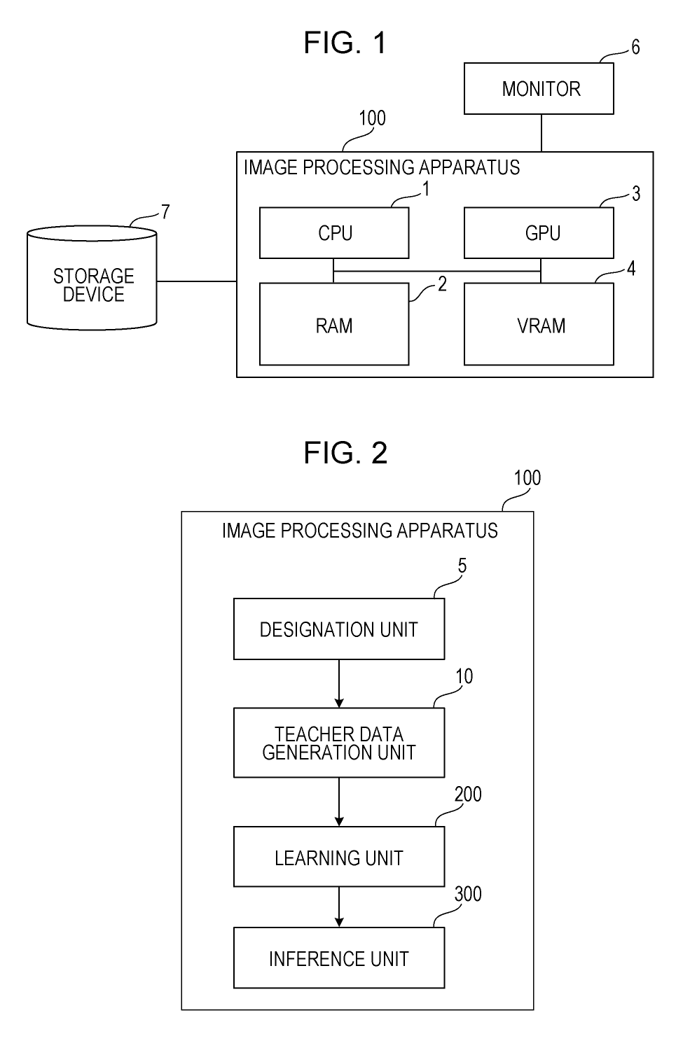

FIG. 1 is a view illustrating hardware configuration of an image processing apparatus 100. A below-mentioned storage device 7 of the image processing apparatus 100 stores an image processing program therein, and a central processing unit (CPU) 1 and a graphics processing unit (GPU) 3 described below read and execute the program, thereby operating as a designation unit 5, a teacher data generation unit 10, a test data generation unit 31, a learning unit 200, and an inference unit 300, which will be described later.

The image processing apparatus 100 in FIG. 1 includes the CPU 1, a random access memory (RAM) 2, the GPU 3, and a video random access memory (VRAM) 4. A monitor 6 and the storage device 7 are connected to the image processing apparatus 100.

The CPU 1 is a unit that executes various programs of the designation unit 5, the teacher data generation unit 10, the test data generation unit 31, the learning unit 200, and the inference unit 300, which are stored in the storage device 7.

The RAM 2 is a volatile memory, and includes a dynamic random access memory (DRAM), a static random access memory (SRAM), and the like.

The GPU 3 is a unit that executes computation for generating masked teacher data in the teacher data generation unit 10 and masked test data in the test data generation unit 31.

The VRAM 4 is a memory area that holds data for displaying an image on a display such as a monitor, and is also referred to as graphic memory or video memory. The VRAM 4 may be a dedicated dual port, or use the same DRAM or SRAM as a main memory.

The monitor 6 is used to confirm the masked teacher data generated by the teacher data generation unit 10 and the masked test data generated by the test data generation unit 31. When the masked teacher data may be confirmed from another terminal connected thereto via a network, the monitor 6 is unnecessary.

The storage device 7 is an auxiliary computer-readable storage device that records various programs installed in the image processing apparatus 100 and data generated by executing the various programs.

The image processing apparatus 100 includes, although not illustrated, a graphic controller, input/output interfaces such as a keyboard, a mouse, a touch pad, and a track ball, and a network interface for connection to the network.

Next, FIG. 2 is a block diagram illustrating an example of the entire image processing apparatus in Embodiment 1. The image processing apparatus 100 illustrated in FIG. 2 includes the designation unit 5, the teacher data generation unit 10, the learning unit 200, and the inference unit 300. The designation unit 5 designates a mask designation area inputted by the operator by using an input device not illustrated including a pointing device such as mouse and track ball, and a keyboard. The mask designation area is a non-target characteristic portion, that is, a characteristic portion relating to only this image, the characteristic portion being a portion which is other than a specific characteristic portion in the image and is desired to be excluded from the learning.

The mask designation area may be designated by software, and may be SIFT, SURF, RIFF, HOG, or a combination thereof.

The teacher data generation unit 10 masks the mask designation area designated by the designation unit 5 to generate the masked teacher data of the recognition target.

The learning unit 200 performs learning using the masked teacher data generated by the teacher data generation unit 10.

The inference unit 300 performs inference (test) using a learnt weight found by the learning unit 200.

At learning, masked teacher data may be used to find the learnt weight that does not learn the portion other than the specific characteristic portion.

At inference, since it is unpractical for the operator to perform masking, for example, inference may be made without masking the test data, or test data may be automatically masked.

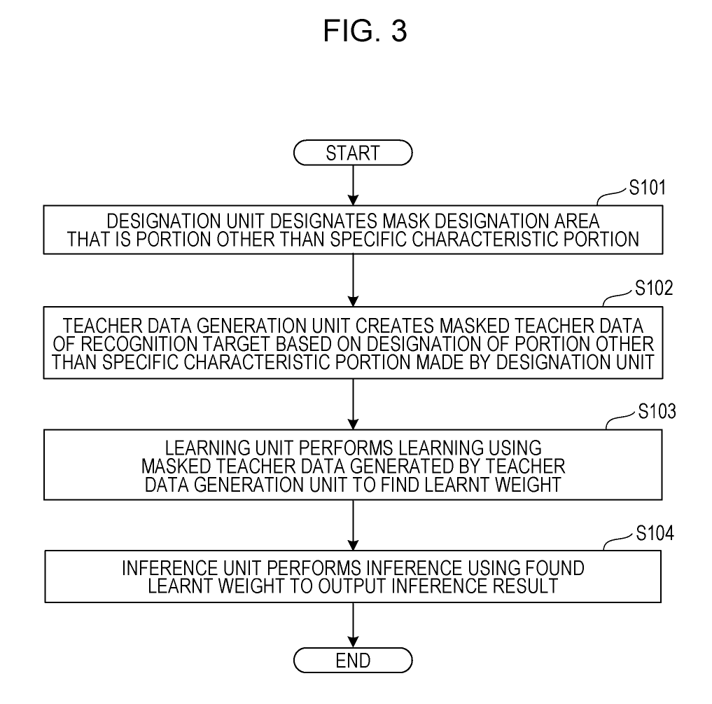

FIG. 3 is a flow chart illustrating an example of the flow of processing of the entire image processing apparatus. Referring to FIG. 2, the flow of processing of the entire image processing apparatus will be described below.

In step S101, the designation unit 5 designates the mask designation area inputted by the operator by using an input device not illustrated including a pointing device such as mouse and track ball, or a keyboard. The mask designation area is a portion other than the specific characteristic portion in the image, which is desired to be excluded from the learning. When designation of the mask designation area is completed in step S101, the processing proceeds to step S102. Alternately, the mask designation area may be designated by software.

In step S102, when the teacher data generation unit 10 generates the masked teacher data of the recognition target based on the portion other than the specific characteristic portion, which is designated by the designation unit 5, the processing proceeds to step S103.

In step S103, when the learning unit 200 performs learning using the masked teacher data generated by the teacher data generation unit 10 to find the learnt weight, the processing proceeds to step S104.

In step S104, when the inference unit 300 performs inference using the found learnt weight and outputs an inference label (inference result), processing is terminated.

The designation unit 5, the teacher data generation unit 10, the learning unit 200, and the inference unit 300 in the image processing apparatus 100 will be specifically described below.

<Designation Unit, Teacher Data Generation Unit>

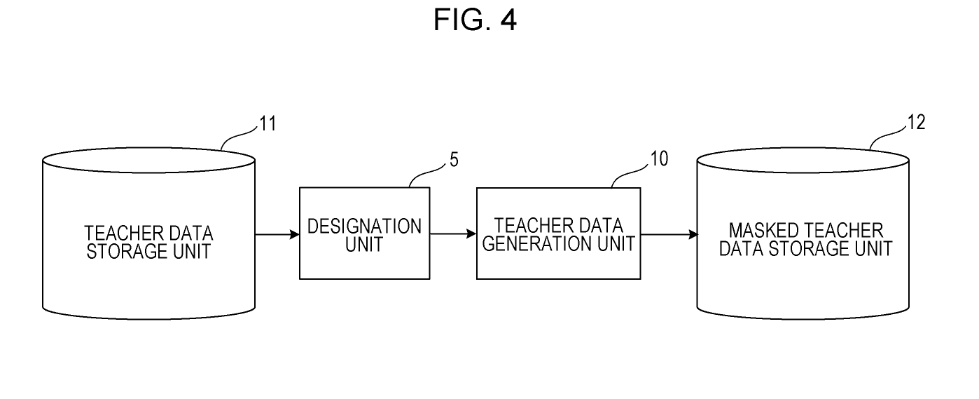

As illustrated in FIG. 4, the teacher data generation unit 10 masks at least a part of a portion other than the non-target characteristic portion in the teacher data designated by the designation unit 5, that is, the specific characteristic portion relating to only this image and is desired to be excluded from the learning, to generate the masked teacher data of the recognition target, and stores the masked teacher data in a masked teacher data storage unit 12.

Configuration of the designation unit 5 and the teacher data generation unit 10 corresponds to the “teacher data generation apparatus” of the disclosure, processing of the designation unit 5 and the teacher data generation unit 10 corresponds to the “teacher data generation method” of the disclosure, and a program that causes a computer to execute the processing of the designation unit 5 and the teacher data generation unit 10 corresponds to the “teacher data generation program” of the disclosure.

To improve the recognition rate of image recognition, it is important to increase variations of the teacher data. However, even when variations of the teacher data increase, if a bias (duplication or deviation) is present in the variations, the portion other than the specific characteristic portion is learnt, although is desired to be excluded from the learning, failing to achieve a satisfactory recognition rate. Thus, by masking the portion other than the specific characteristic portion as the non-target characteristic portion to generate the masked teacher data, the portion other than the specific characteristic portion may be excluded from the learning to improve the recognition rate.

A teacher data storage unit 11 stores unmasked teacher data, and the stored teacher data may be identified according to respective teacher data ID.

The masked teacher data storage unit 12 stores masked teacher data. The stored masked teacher data are associated with the teacher data in the teacher data storage unit 11 according to the teacher data ID.

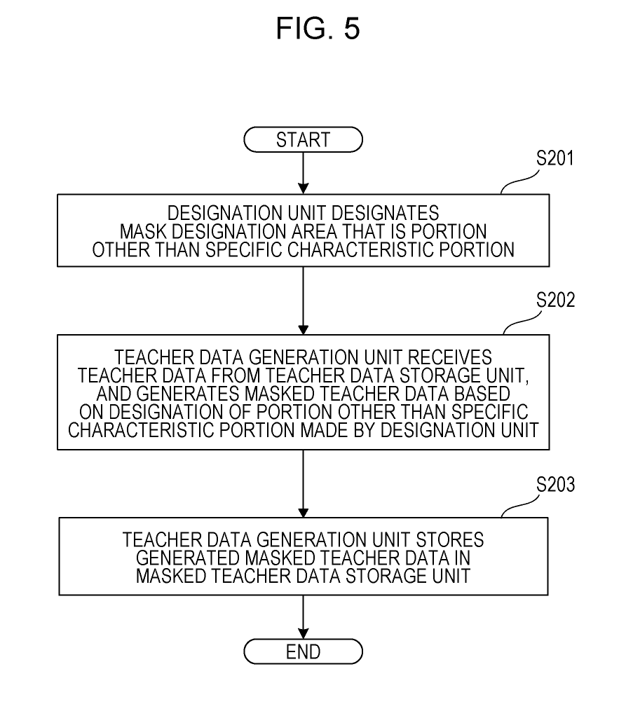

FIG. 5 is a flow chart illustrating an example of the flow of processing of the designation unit and the teacher data generation unit. Referring to FIG. 4, the flow of the processing of the designation unit and the teacher data generation unit will be described below.

In step S201, the designation unit 5 designates the mask designation area that is the portion other than the specific characteristic portion in the image, which is desired to be excluded from the learning, by an operator's input using a pointing device such as mouse or track ball, or a keyboard, and the processing proceeds to step S202. Alternatively, the mask designation area may be designated by software, or SIFT, SURF, RIFF, HOG, or a combination thereof may be used.

In step S202, the teacher data generation unit 10 receives an input of the teacher data in the teacher data storage unit 11, and generates the masked teacher data based on designation of the portion other than the specific characteristic portion by the designation unit 5.

In step S204, the teacher data generation unit 10 stores the masked teacher data in the masked teacher data storage unit 12. After S204, processing is terminated.

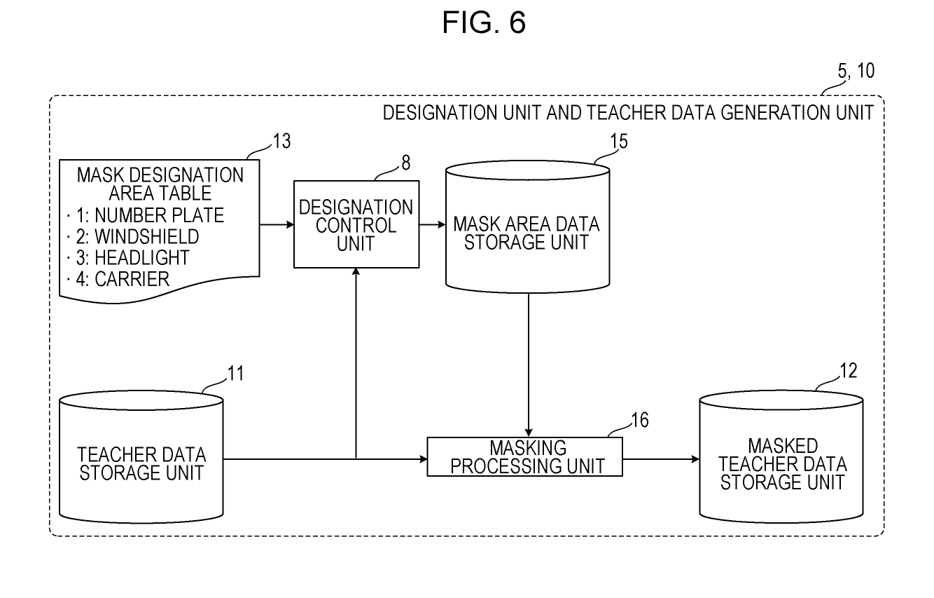

Next, FIG. 6 is a block diagram illustrating an example of the designation unit and the teacher data generation unit.

Under control of a designation control unit 8, the designation unit 5 creates mask area data for images of all teacher data stored in the teacher data storage unit 11 according to a mask designation area table 13, stores the mask area data in a mask area data storage unit 15, and executes processing of a masking processing unit 16. Processing of the designation control unit 8 is executed by the operator or software.

The mask designation area table 13 describes the mask designation area that is the portion other than the specific characteristic portion in the image of the teacher data, and a mask ID associated therewith.

The operator creates the mask area data according to the mask designation area table 13, and stores the mask area data with the mask ID in the mask area data storage unit 15.

For example, in the case of automobile, a mask designation area as illustrated in a following table 2 may be used.

TABLE 2

| Mask ID | Mask designation area |
|---|---|
| 1 | Number plate |
| 2 | Windshield |
| 3 | Headlight |

The operator designates a number plate as it represents unique numerical characters and is not a specific characteristic portion of the automobile. The operator designates a windshield as a passenger may be seen through the windshield and is not a specific characteristic portion of the automobile. The operator designates a headlight as it varied in reflection depending on an automobile and is not a specific characteristic portion of the automobile. SIFT, SURF, RIFF, or HOG also obtains the same result as the operator's designation.

The mask area data storage unit 15 stores a pair of mask designation area bitmap corresponding to teacher data and a mask ID. For each teacher data ID, a pair of 0 or more mask designation area bitmaps and the mask ID is present.

For example, in the case of automobile, a following table 3 may be used.

TABLE 3

| Teacher data | Mask | |
|---|---|---|
| ID | ID | Bitmap of mask designation area |
| 1 | 1 | Bitmap of number plate |
| 1 | 3 | Bitmap of headlight |
| 3 | 2 | Bitmap of windshield |

The masking processing unit 16 masks the mask area data associated with all of the teacher data stored in the teacher data storage unit 11 according to a specified algorithm.

Examples of masking method include filling of a single color and Gaussian filter blur.

A learning result varies according to the masking method. Preferably, the most suitable masking method is selected through learning using a plurality of patterns.

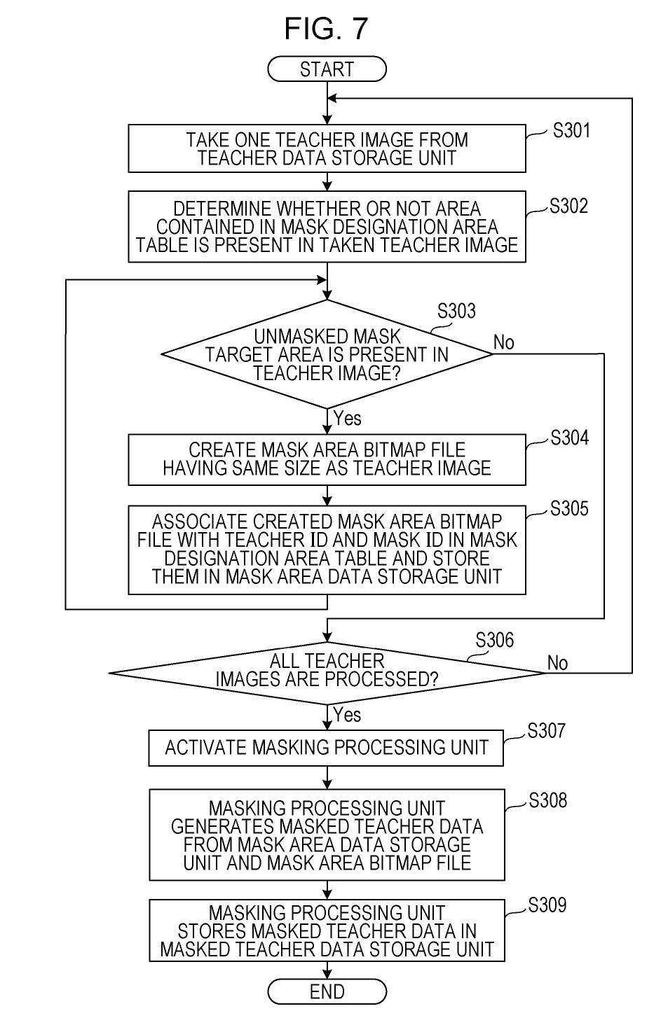

FIG. 7 is a flow chart illustrating an example of the flow of processing of the teacher data generation unit. Referring to FIG. 6, the flow of processing of the teacher data generation unit will be described below.

In step S301, the operator or software that is the designation control unit 8 takes one teacher (or training) image from the teacher data storage unit 11.

In step S302, when the operator determines whether or not the mask designation area contained in the mask designation area table 13 is present in the taken teacher image, the processing proceeds to step S303. Alternatively, software may automatically determine whether or not the mask designation area contained in the mask designation area table 13 is present in the taken teacher image.

In step S303, the operator determines whether or not any unmasked mask designation area is present in the teacher image. When the operator determines that any unmasked mask designation area is not present, the processing proceeds to step S306. Meanwhile, when the operator determines that any unmasked mask designation area is present, the processing proceeds to step S304. Alternatively, software may automatically determine the presence or absence of the mask designation area.

In the step S304, the operator or software creates a mask designation area bitmap file having the same size as the teacher image.

In step S305, when the operator associates the created mask designation area bitmap file with the teacher data ID and the mask ID in the mask designation area table 13, and stores them in the mask area data storage unit 15, the processing proceeds to step S303. Alternatively, software may automatically associate the mask area bitmap file with the teacher data ID and the mask ID in the mask designation area table 13, and store them in the mask area data storage unit 15.

In step S306, the operator determines whether or not all teacher images are processed. When the operator determines that all teacher images are not processed, the processing proceeds to step S301. When the operator determines that all teacher images are processed, the processing proceeds to step S307. Alternatively, software may automatically determine whether or not all teacher images are processed.

In step S307, when the operator or software activates the masking processing unit 16, the processing proceeds to step S308.

In step S308, when the masking processing unit 16 generates the masked teacher data from the teacher data storage unit 11 and the mask area bitmap in the mask area data storage unit 15, the processing proceeds to step S309.

In step S309, the masking processing unit 16 stores the masked teacher data in the masked teacher data storage unit 12. After S309, processing is terminated.

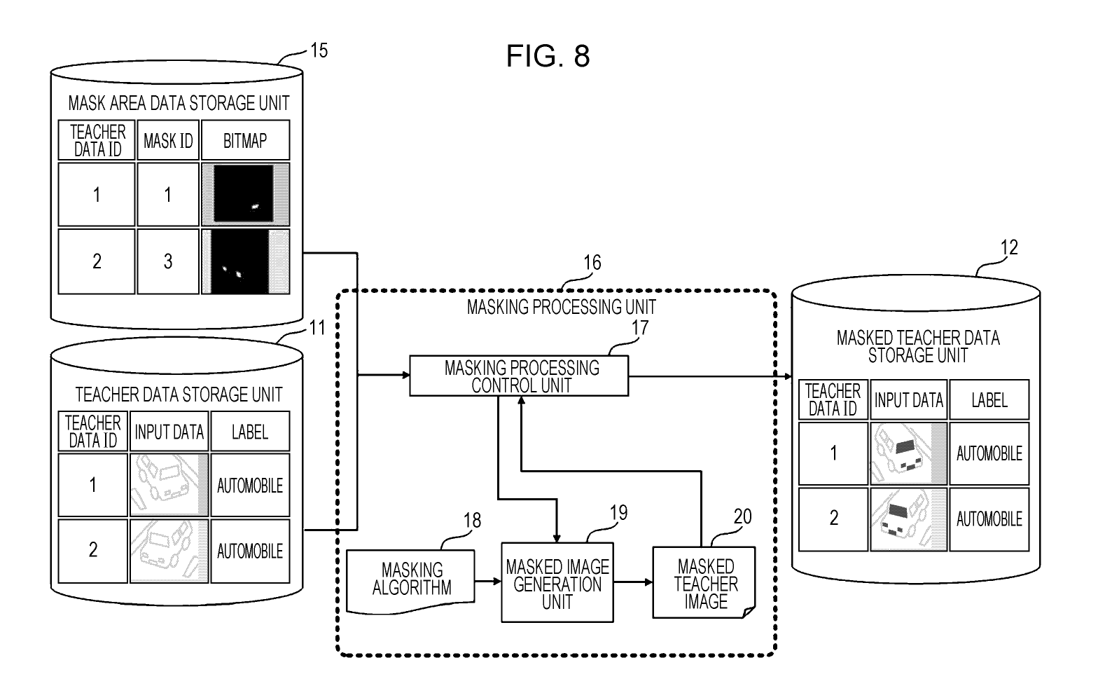

FIG. 8 is a block diagram illustrating an example of the masking processing unit 16.

The masking processing unit 16 is controlled by a masking processing control unit 17.

The masking processing control unit 17 applies masking to all of the teacher data in the teacher data storage unit 11 based on mask information in the mask area data storage unit 15, and stores masked teacher data in the masked teacher data storage unit 12.

A masking algorithm 18 is a parameter inputted by the operator to designate an algorithm on the masking processing method (filling of single color, blur, and so on).

A masked image generation unit 19 receives inputs of one original bitmap image (teacher image) and a plurality of binary mask area bitmap images, and generates a masked teacher image 20 in which the mask area bitmap images are masked according to the masking algorithm 18.

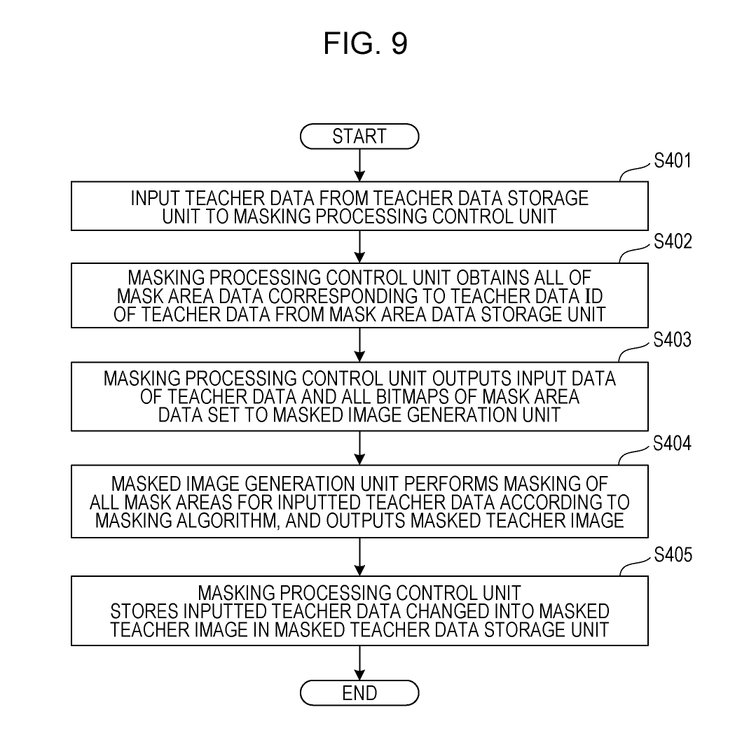

FIG. 9 is a flow chart illustrating an example of the flow of processing of the masking processing unit. Referring to FIG. 8, the flow of processing of the masking processing unit will be described below.

In step S401, the operator or software inputs teacher data from the teacher data storage unit 11 to the masking processing control unit 17.

In step S402, the masking processing control unit 17 obtains all of mask area data corresponding to the teacher data ID of the teacher data from the mask area data storage unit 15.

In step S403, the masking processing control unit 17 outputs input data of teacher data and all bitmaps of a mask area data set to the masked image generation unit 19, the processing proceeds to step S404.

In step S404, the masked image generation unit 19 performs masking of all mask areas for the inputted teacher data according to the masking algorithm inputted by the operator, and outputs the masked teacher image.

In step S405, the masking processing control unit 17 stores the inputted teacher data changed into the masked teacher image 20 in the masked teacher data storage unit 12. After S405, processing is terminated.

In this manner, the portion other than the specific characteristic portion in the image of teacher data may be excluded from the learning to generate teacher data capable of improving the recognition rate. The generated teacher data is suitably used in the learning unit and the inference unit.

<Learning Unit>

The learning unit 200 performs learning using the masked teacher data generated by the teacher data generation unit 10.

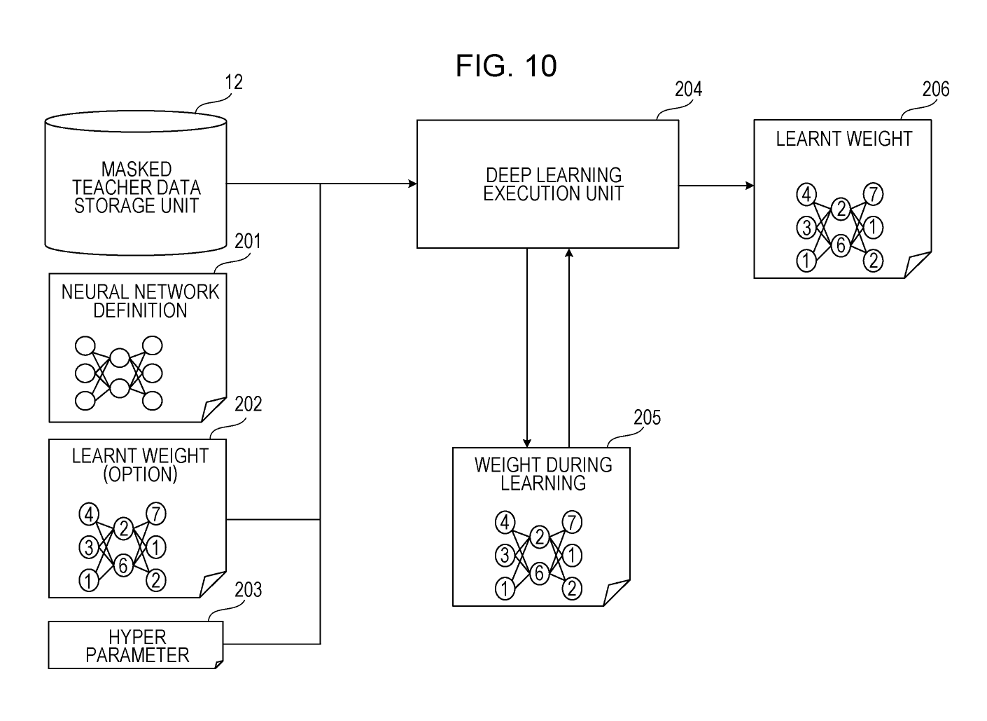

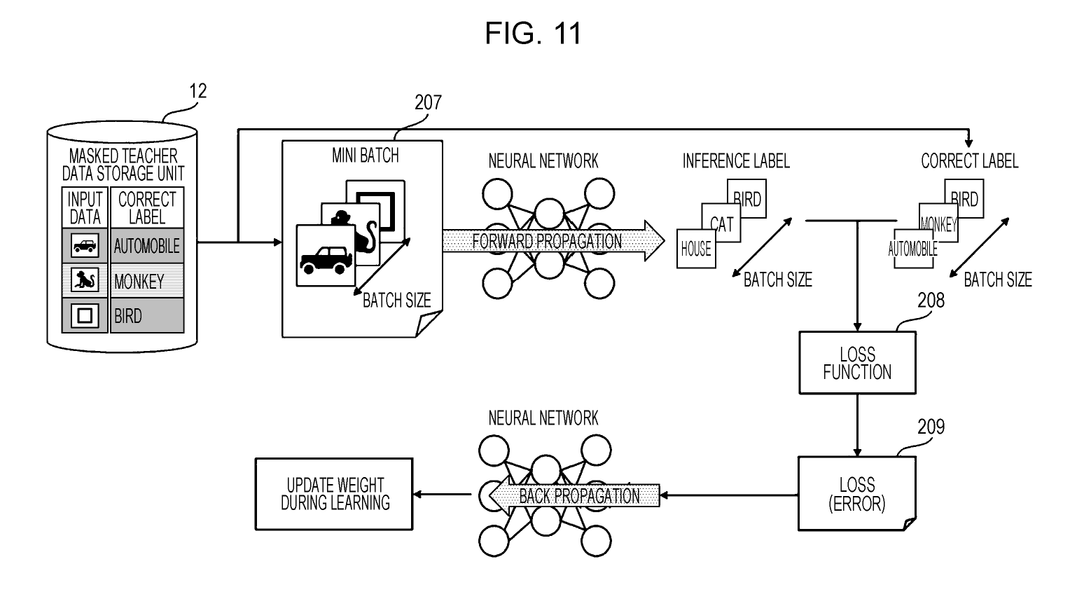

FIG. 10 is a block diagram illustrating an example of the entire learning unit, and FIG. 11 is a block diagram illustrating another example of the entire learning unit.

The learning using the masked teacher data generated by the teacher data generation unit 10 may be performed in the same manner as normal deep learning.

The masked teacher data storage unit 12 illustrated in FIG. 10 stores masked teacher data that is a pair of input data (image) generated by the teacher data generation unit 10 and a correct label.

A neural network definition 201 is a file that defines the type of the multi-layered neural network (deep neural network), which indicates how a lot of neurons are interconnected, and is an operator-designated value.

A learnt weight 202 is an operator-designated value. Generally, at start of learning, the learnt weight is assigned in advance. The learnt weight is a file that stores the weight of each neuron in the neural network. It is noted that learning does not necessarily require the learnt weight.

A hyper parameter 203 is a group of parameters related to learning, and is a file that stores the number of times learning is made, the frequency of update of weight during learning, and so on.

A weight during learning 205 represents the weight of each neuron in the neural network during learning, and is updated by learning.

As illustrated in FIG. 11, a deep learning execution unit 204 obtains the masked teacher data in the unit of mini-batch 207 from the masked teacher data storage unit 12. The masked teacher data separates the input data from the correct label to execute forward propagation processing and back propagation processing, thereby updating the weight during learning and outputting the learnt weight.

A condition for termination of learning is determined depending on whether an input to the neural network, or a loss function 208 falls below a threshold.

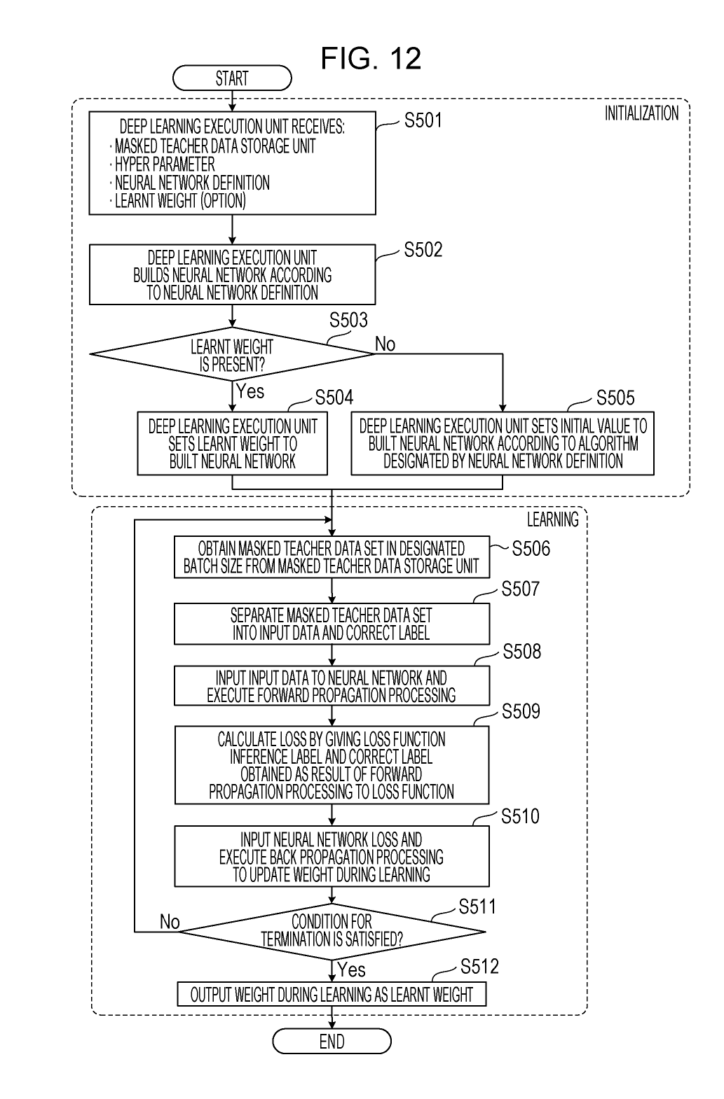

FIG. 12 is a flow chart illustrating the flow of processing of the entire learning unit. Referring to FIGS. 10 and 11, the flow of processing of the entire learning unit will be described below.

In step S501, the deep learning execution unit 204 receives the masked teacher data storage unit 12, the neural network definition 201, the hyper parameter 203, and the learnt weight 202, which is optional.

In step S502, the deep learning execution unit 204 builds the neural network according to the neural network definition 201.

In step S503, the deep learning execution unit 204 determines whether or not the learnt weight 202 is present.

When it is determined that the learnt weight 202 is absent, the deep learning execution unit 204 sets an initial value to the built neural network according to the algorithm designated by the neural network definition 201, and the processing proceeds to step S506. Meanwhile, when it is determined that the learnt weight 202 is present, the deep learning execution unit 204 sets the learnt weight 202 to the built neural network, and the processing proceeds to step S506. The initial value is described in the neural network definition 201.

In step S506, the deep learning execution unit 204 obtains a masked teacher data set in the designated batch size from the masked teacher data storage unit 12.

In step S507, the deep learning execution unit 204 separates the masked teacher data set into “input data” and “correct label”.

In step S508, the deep learning execution unit 204 inputs “input data” to the neural network, and executes forward propagation processing.

In step S509, the deep learning execution unit 204 gives “inference label” and “correct label” obtained as a result of forward propagation processing to the loss function 208, and calculates the loss 209. The loss function 208 is described in the neural network definition 201.

In step S510, the deep learning execution unit 204 inputs the loss 209 to the neural network, and executes back propagation processing to update the weight during learning.

In step S511, the deep learning execution unit 204 determines whether or not the condition for termination is satisfied. When the deep learning execution unit 204 determines that the condition for termination is not satisfied, the processing returns to step S506, and when the deep learning execution unit 204 determines that the condition for termination is satisfied, the processing proceeds to step S512. The condition for termination is described in the hyper parameter 203.

In step S512, the deep learning execution unit 204 outputs the weight during learning as the learnt weight. After S512, processing is terminated.

<Inference Unit>

To evaluate a learning result, the inference unit 300 performs inference (test) using the learnt weight found by the learning unit 200.

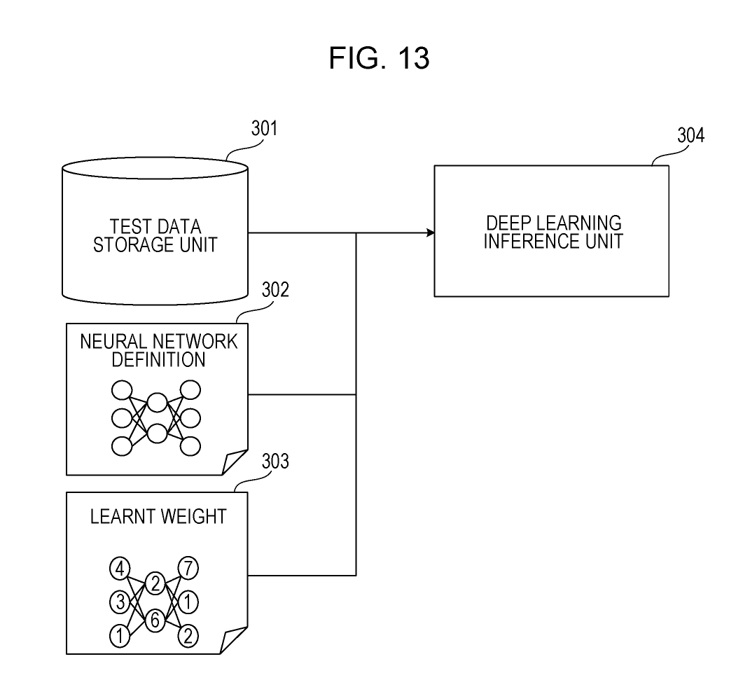

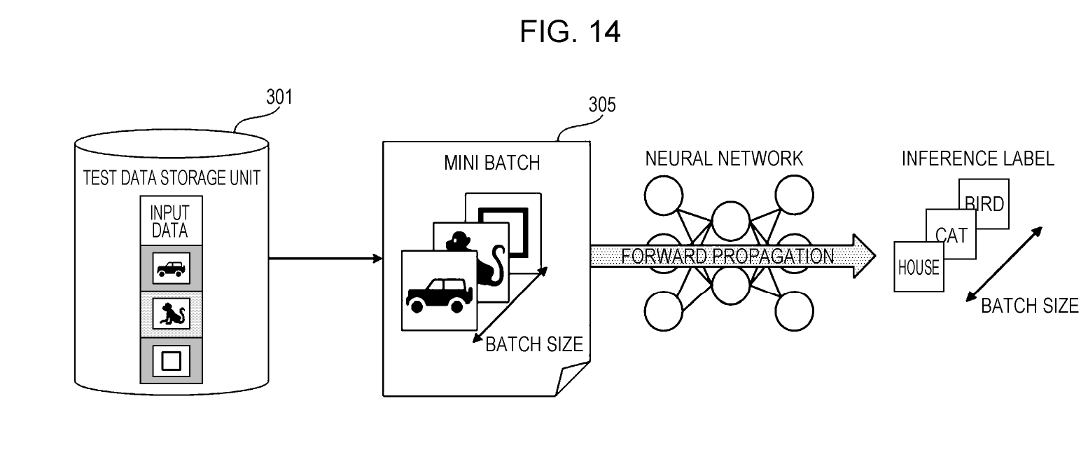

FIG. 13 is a block diagram illustrating an example of the entire inference unit, and FIG. 14 is a block diagram illustrating another example of the entire inference unit.

Inference using a test data storage unit 301 may be made as in the same manner as normal deep learning inference.

The test data storage unit 301 stores test data for inference. The test data includes only input data (image).

A neural network definition 302 and the neural network definition 201 in the learning unit 200 have the common basic structure.

To evaluate a learning result, a learnt weight 303 is usually given.

A deep learning inference unit 304 corresponds to the deep learning execution unit 204 in the learning unit 200.

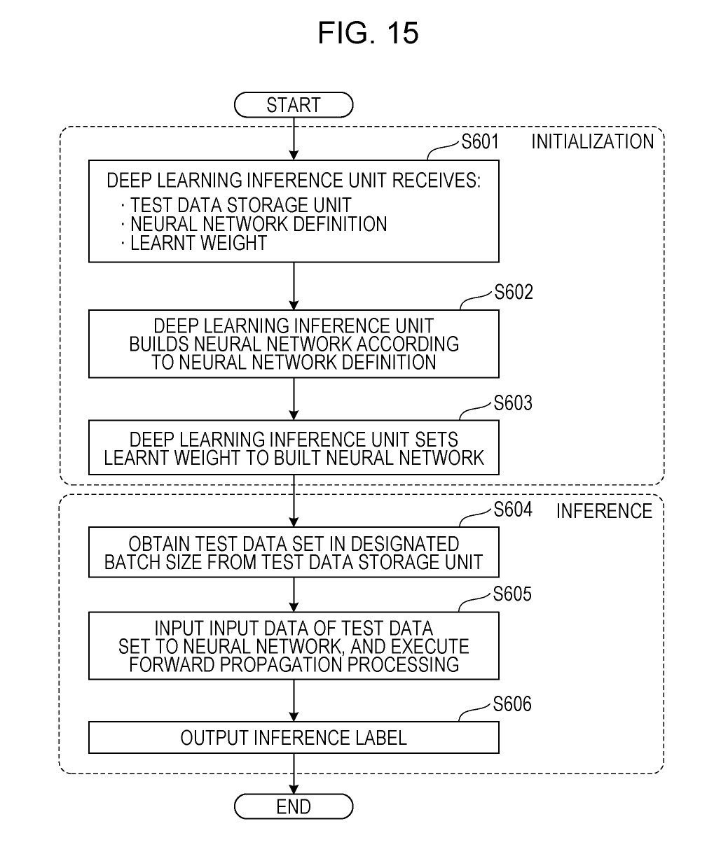

FIG. 15 is a flow chart illustrating the flow of processing of the entire inference unit. Referring to FIGS. 13 and 14, the flow of processing of the entire inference unit will be described below.

In step S601, the deep learning inference unit 304 receives the test data storage unit 301, the neural network definition 302, and the learnt weight 303.

In step S602, the deep learning inference unit 304 builds the neural network according to the neural network definition 302.

In step S603, the deep learning inference unit 304 sets the learnt weight 303 to the built neural network.

In step S604, the deep learning inference unit 304 obtains a masked teacher data set in the designated batch size from the test data storage unit 301.

In step S605, the deep learning inference unit 304 inputs input data of a test data set to the neural network, and executes forward propagation processing.

In step S606, the deep learning inference unit 304 outputs an inference label (inference result). After S606, processing is terminated.

In this manner, about 10% of an object that could not be recognized without the image processing apparatus in Embodiment 1 could be recognized using the image processing apparatus in Embodiment 1. Here, teacher data of the target to be evaluated includes images of four types of automobiles as teacher data: one with number plate and three without number plate, while test data includes four types of automobiles with number plate.

As apparent from the result, the image processing apparatus in Embodiment 1 may learn a unique characteristic of the teacher data.

### Embodiment 2

An image processing apparatus in Embodiment 2 is the same as the image processing apparatus in Embodiment 1 except that, when the masked teacher data generated by the teacher data generation unit 10 has a plurality of masks, only any of the masks is masked.

This is achieved by changing masking of all mask designation areas in step S404 in FIG. 9 in Embodiment 1 to randomly masking of one or more mask designation areas.

As in the same manner as Embodiment 1, the image processing apparatus in Embodiment 2 could recognize the target that could not be recognized without using the image processing apparatus in Embodiment 2, with a higher recognition rate than Embodiment 1.

### Embodiment 3

An image processing apparatus in Embodiment 3 is the same as the image processing apparatus in Embodiment 1 except that automatic masking is performed by the mask area data storage unit 15 in the image processing apparatus in Embodiment 1 to obtain masked teacher data, and learning and inference is performed using the obtained masked test data. Thus, the same elements are given the same reference numerals and description thereof is omitted.

In automatic masking in Embodiment 3, teacher data is configured of the image of the teacher data as input data, and a correct label as a pair of corresponding mask area bitmap and mask ID, and the mask area may be automatically detected by a deep learning method referred to as semantic segmentation.

Implementations of semantic segmentation are as follows:
FCN (https://people.eecs.berkeley.edu/˜jonlong/long_shelhamer_fcn.pdf)
deconvnet (http://cvlab.postech.ac.kr/research/deconvnet/)
DeepMask (https://github.com/facebookresearch/deepmask)

Semantic segmentation is a neural network that receives an input of an image and outputs a mask (binary bitmap) indicating which area in the image an object to be detected is present.

In the example illustrated in FIG. 8, masks of number plate and headlight may be outputted as the non-target characteristic portions, that is, the characteristic portions relating to only this image, and being portions other than the specific characteristic portion, which are desired to be excluded from the learning.

Since a pair of input and output to and from the neural network are the input data for learning and the inference label, the input data may be fetched from the teacher data storage unit 11, and the inference label may be fetched from the mask area data storage unit 15 in Embodiment 1, so that teacher data for semantic segmentation can be configured.

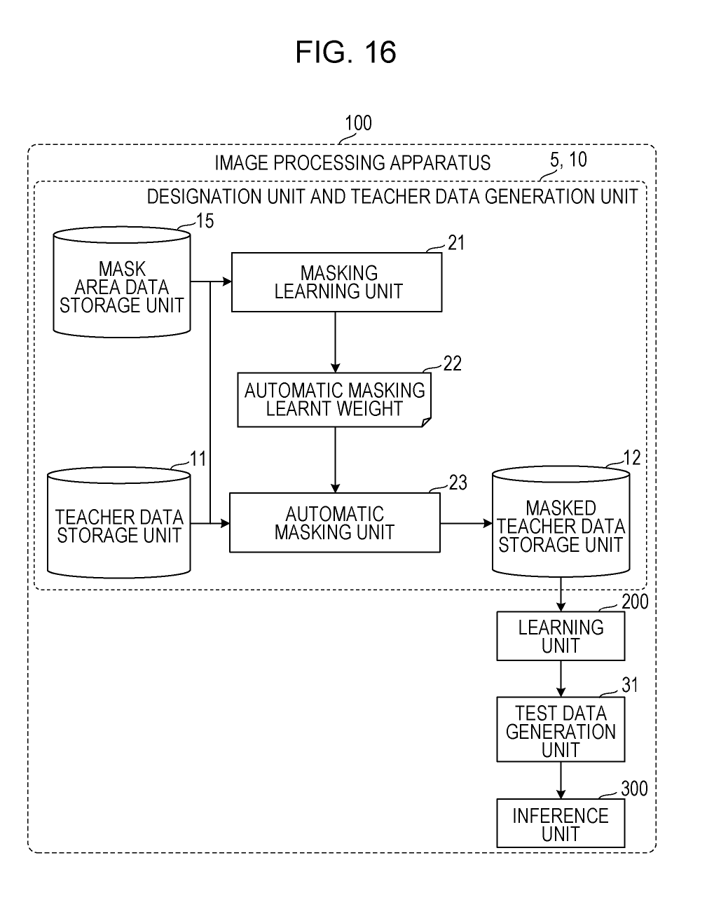

FIG. 16 is a block diagram illustrating an example of the entire image processing apparatus in Embodiment 3. The image processing apparatus 100 in FIG. 16 includes a designation unit 5, a teacher data generation unit 10, a learning unit 200, a test data generation unit 31, and an inference unit 300.

The mask area data storage unit 15 created by the operator in Embodiment 1 is used. That is, the mask area data in Embodiment 1 is used as correct data of teacher data in a masking learning unit 21.

The teacher data storage unit 11 stores teacher data, and the teacher data is used as input data of teacher data in the masking learning unit 21 and an input to an automatic masking unit 23.

The masking learning unit 21 uses a combination of the teacher data storage unit 11 and the mask area data storage unit 15 as teacher data of semantic segmentation, and learns an automatic masking learnt weight 22.

The automatic masking unit 23 applies semantic segmentation to the teacher data inputted from the teacher data storage unit 11 using the automatic masking learnt weight 22 obtained by the masking learning unit 21 to generate masked teacher data, and stores the obtained masked teacher data in the masked teacher data storage unit 12.

The learning unit 200 is the same as the learning unit 200 in Embodiment 1.

The test data generation unit 31 masks the mask designation area that is at least a part of a portion other than the specific characteristic portion in the image of the test data of the recognition target to generate masked test data of the recognition target.

The inference unit 300 is the same as the learning unit in Embodiment 1 except that the masked test data generated by the test data generation unit 31 is used.

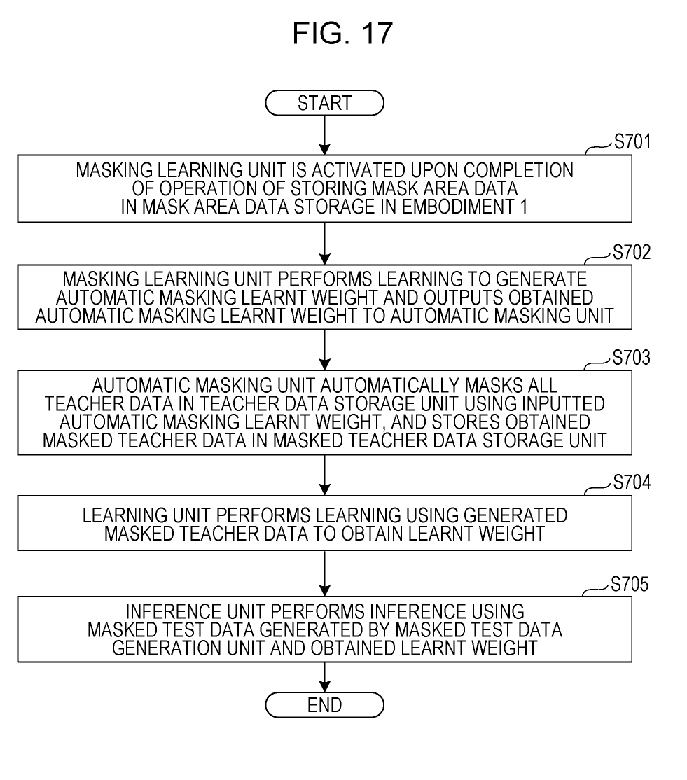

FIG. 17 is a flow chart illustrating an example of the flow of processing of the entire image processing apparatus in Embodiment 3. Referring to FIG. 16, the flow of processing of the entire image processing apparatus in Embodiment 3 will be described below.

In step S701, the masking learning unit 21 is activated in response to a trigger which is completion of operation of storing the mask area data in the mask area data storage unit 15 in Embodiment 1, and the processing proceeds to step S702.

In step S702, the masking learning unit 21 performs learning to generate the automatic masking learnt weight 22, and inputs the generated automatic masking learnt weight 22 to the automatic masking unit 23.

In step S703, the automatic masking unit 23 automatically masks all of teacher data contained in the teacher data storage unit 11 using the inputted automatic masking learnt weight 22, and stores the obtained masked teacher data in the masked teacher data storage unit 12.

In step S704, the learning unit 200 performs learning using the generated masked teacher data to obtain a learnt weight.

In step S705, the inference unit 300 performs inference using the masked test data generated by the test data generation unit 31 and the learnt weight obtained by the learning unit 200, and outputs an inference label (inference result). After S705, processing is terminated.

<Masking Learning Unit>

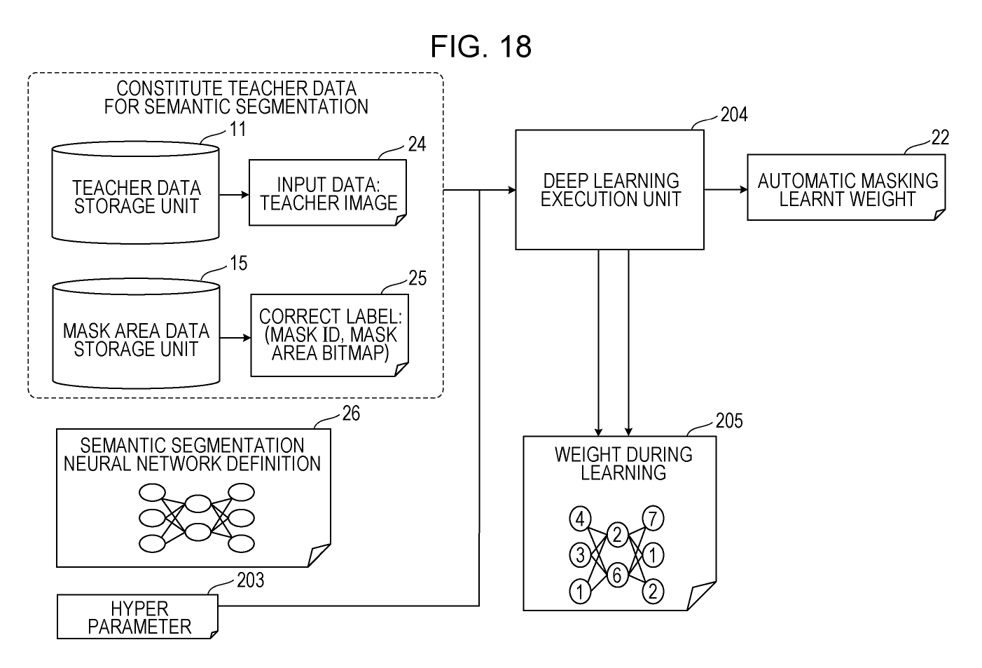

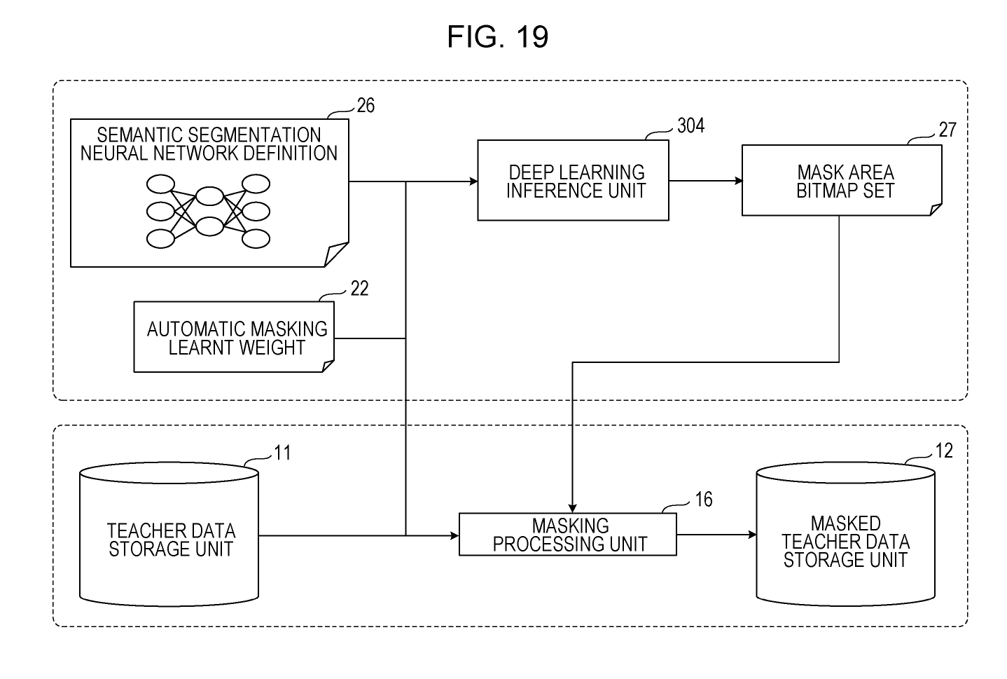

FIG. 18 is a block diagram illustrating an example of the masking learning unit 21 in Embodiment 3.

The masking learning unit 21 performs learning by semantic segmentation using the teacher image in the teacher data storage unit 11 as input data, and the correct label as a pair of mask area mask ID and mask area bitmap in mask information associated with the teacher image of the input data and teacher data ID.

The masking learning unit 21 receives an input of the teacher data, performs learning by semantic segmentation, and outputs the automatic masking learnt weight 22.

Learning by semantic segmentation is the same as normal learning except that the above-mentioned teacher data and a semantic segmentation neural network definition 26 are used.

The semantic segmentation neural network definition 26 is the same as a normal neural network definition except that the type of multi-layered neural network (deep neural network) is semantic segmentation, and is an operator-designated value.

<Automatic Masking Unit>

FIG. 19 is block diagram illustrating an example of the automatic masking unit 23 in Embodiment 3.

The automatic masking unit 23 is configured by replacing the mask area data storage unit 15 in the teacher data generation unit 10 in Embodiment 1 in FIG. 6 with the deep learning inference unit 304 using semantic segmentation learnt by the masking learning unit 21.

The deep learning inference unit 304 uses teacher data stored in the teacher data storage unit 11 as input data, performs semantic segmentation based on the automatic masking learnt weight 22, and outputs a mask area bitmap set 27 to the masking processing unit 16.

The masking of the masking processing unit 16 is the same as that in Embodiment 1.

<Learning Unit>

The learning unit 200 is the same as the learning unit 200 using the masked teacher data in Embodiment 1.

<Inference Unit>

The inference unit 300 executes the same processing as normal inference except that test data (image) is used, and the test data is automatically masked by the semantic segmentation deep learning inference unit.

Automatic masking enables masking at inference. Since masking may be achieved at inference at the same level as at learning, the recognition rate may be improved.

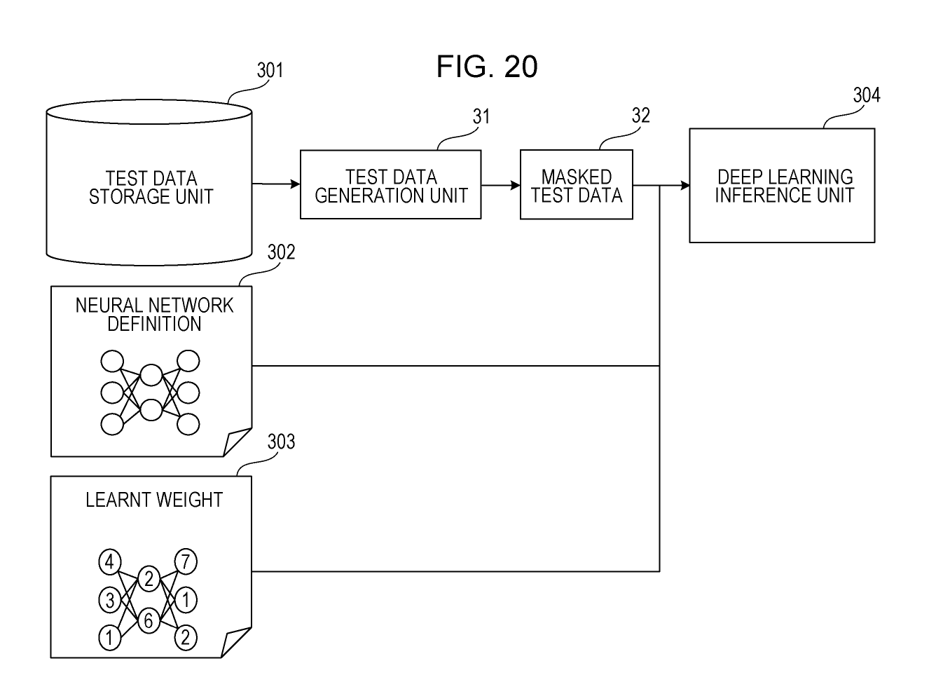

FIG. 20 is a block diagram illustrating the entire inference unit in Embodiment 3.

The test data storage unit 301 stores test data (image) for inference.

The test data generation unit 31 performs semantic segmentation using the automatic masking learnt weight 22 to generate a masked test data 32.

The neural network definition 302 and the learnt weight 303 are the same as the inference unit in Embodiment 1.

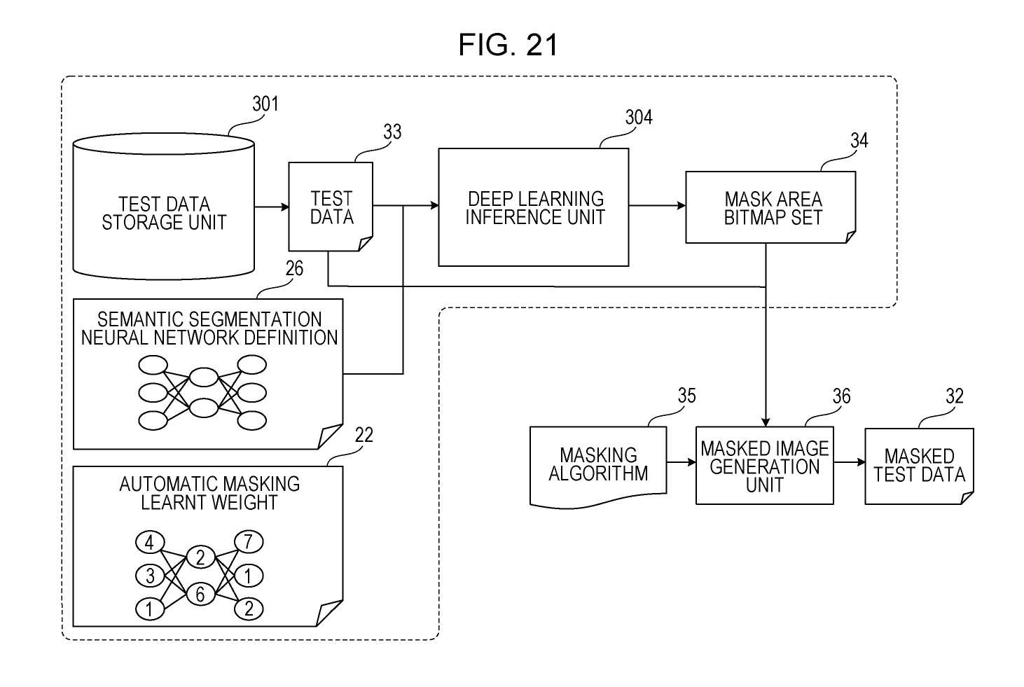

FIG. 21 is a block diagram illustrating an example of the test data generation unit 31 in Embodiment 3.

The test data generation unit 31 receives test data (image) 33 from the test data storage unit 301, performs semantic segmentation using the automatic masking learnt weight 22, and outputs the masked test data 32.

A masking algorithm 35 is the same as the masking algorithm 18 in the masking processing unit in Embodiment 1.

A masked image generation unit 36 is the same as the masked image generation unit 19 in the masking processing unit in Embodiment 1.

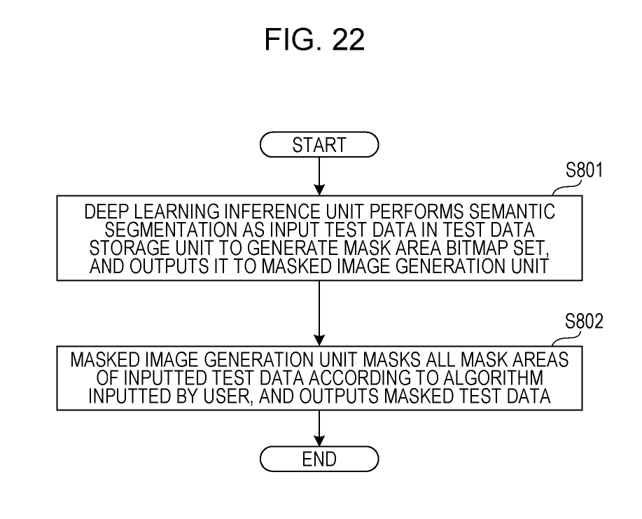

FIG. 22 is a flow chart illustrating the flow of processing of the test data generation unit 31 in Embodiment 3. Referring to FIG. 21, the flow of processing of the test data generation unit 31 will be described below.

In step S801, the deep learning inference unit 304 receives the inputted test data (image) 33 in the test data storage unit 301, and performs semantic segmentation to generate a mask area bitmap set 34, and outputs the generated mask area bitmap set 34 to the masked image generation unit 36.

In step S802, the masked image generation unit 36 masks all mask areas of the test data according to the masking algorithm 35 inputted by the operator, and outputs the masked test data 32. After S802, processing is terminated.

As in the same manner as in Embodiment 1, the image processing apparatus in Embodiment 3 could recognize the target that could not be recognized without using the image processing apparatus in Embodiment 3 at the same level as in Embodiment 1.

### Embodiment 4

An image processing apparatus in Embodiment 4 is the same as the image processing apparatus in Embodiment 3 except that, when masked test data generated by the test data generation unit 31 has a plurality of masks, only some of the masks are masked to further generate masked test data.

Here, the masked test data is test data masked at one or more areas.

To selectively remove some of multiple masks of the masked test data, for example, some masks may be selected from the masked test data by random processing using random numbers.

As in the same manner as Embodiment 1, the image processing apparatus in Embodiment 4 could recognize the target that could not be recognized without using the image processing apparatus in Embodiment 4, with a higher recognition rate than Embodiment 3.

### Embodiment 5

An in Embodiment 5 is the same as the image processing apparatus in Embodiment 3 except that a target to be inferred by the inference unit is streaming moving-image, and inference is performed in real time and/or non-real time. Thus, the same elements are given the same reference numerals and description thereof is omitted.

In Embodiment 5, in the inference unit 300 in Embodiment 3, the test data storage unit 301 is changed for streaming moving-image. Thus, for example, in the case where inference processing in deep learning does not have to be executed in real time, an inference trigger control mechanism is provided.

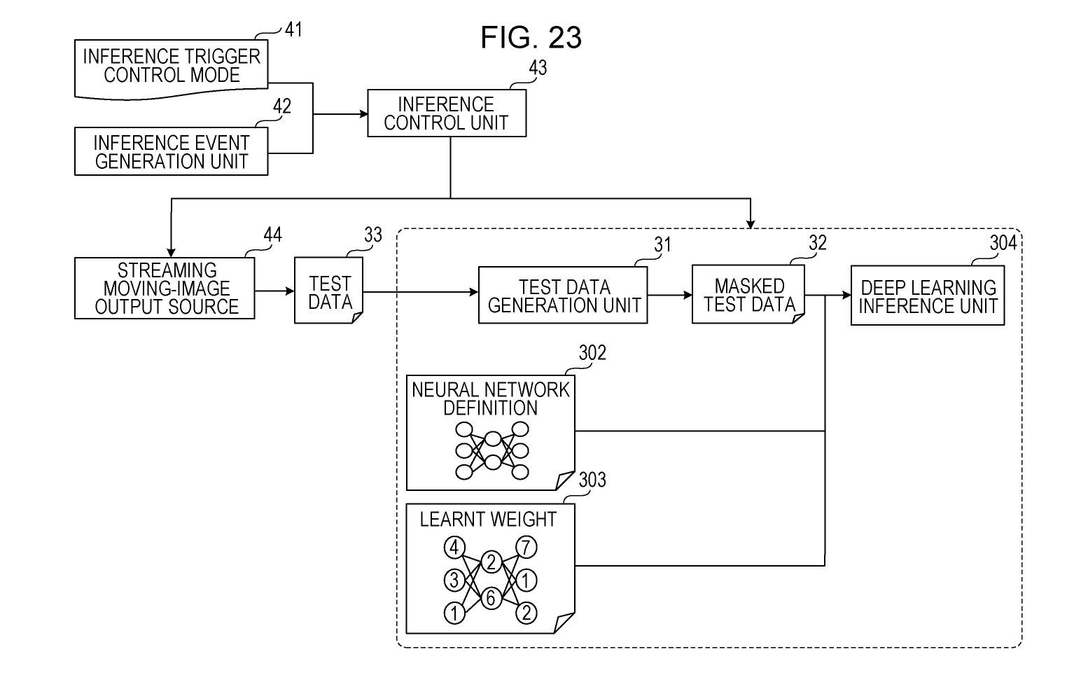

FIG. 23 is a block diagram illustrating an example of the entire inference unit of the image processing apparatus in Embodiment 5.

An inference trigger control mode 41 is a parameter assigned by the operator, and specifies a trigger for inference of periodical event as follows, and issues it to an inference control unit 43.
All frames
Regular interval
Depend on inference event generation unit

An inference event generation unit 42 issues an irregular event, a pattern of which the operator of a sensor or the like may not describe, to the inference control unit 43 based on sensor information. Examples of the event include opening/closing of a door and passage of a walking person.

The inference control unit 43 obtains a latest frame from a streaming moving-image output source 44 at a timing of the inference trigger control mode 41 or the inference event generation unit 42, and outputs the frame as a test image to the same inference unit 300 as the inference unit 300 in Embodiment 3.

The streaming moving-image output source 44 is an output source of streaming moving-image.

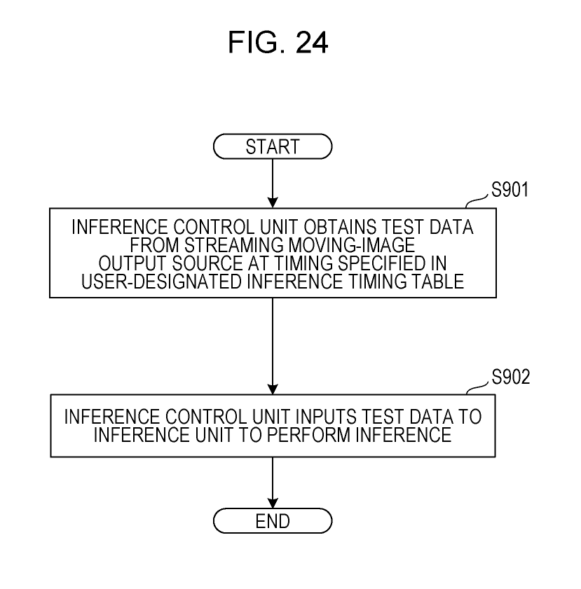

FIG. 24 is a flow chart illustrating the flow of processing of the entire inference unit in Embodiment 5. Referring to FIG. 23, the flow of processing of the entire inference unit in Embodiment 5 will be described below.

In step S901, the inference control unit 43 obtains the test data (image) 33 from the streaming moving-image output source 44 at a timing described in an operator-designated inference timing table.

In step S902, when the inference control unit 43 inputs the data image to the inference unit 300 and performs inference. After S902, processing is terminated.

As in the same manner as in Embodiment 1, the image processing apparatus in Embodiment 5 could recognize the target that could not be recognized without using the image processing apparatus in Embodiment 5 at the same level as in Embodiment 1.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. An image processing apparatus that performs image recognition using teacher data of a recognition target, the apparatus comprising:
a memory, and
a processor coupled to the memory and configured to execute a process including:
designating a mask designation area which is at least a part of a portion other than a specific characteristic portion in an image of the teacher data of the recognition target; and
generating masked teacher data by masking the designated mask designation area of the teacher data of the recognition target.

2. The image processing apparatus according to claim 1, wherein in the generating the masked teacher data,
when a plurality of mask designation areas are designated, masked teacher data, in which at least one of the mask designation areas is unmasked, is further generated.

3. The image processing apparatus according to claim 1, wherein the process further including:
performing learning using the generated masked teacher data.

4. The image processing apparatus according to claim 3, wherein the process further including:
performing inference using learnt weight generated in the performing learning.

5. The image processing apparatus according to claim 1, the process further including:
generating masked test data by masking the mask designation area in an image of test data on the recognition target.

6. The image processing apparatus according to claim 5, wherein in the generating the masked test data,
when a plurality of mask designation areas are designated, masked test data, in which at least one of the mask designation areas is unmasked, is further generated.

7. The image processing apparatus according to claim 5, the process further including:
performing inference using the generated masked test data.

8. The image processing apparatus according to claim 1, wherein the image recognition is performed by deep learning.

9. An image processing method performed by a computer for an image recognition using teacher data of a recognition target, the method comprising:
designating a mask designation area which is at least a part of a portion other than a specific characteristic portion in an image of the teacher data of the recognition target; and
generating masked teacher data by masking the designated mask designation area of the teacher data of the recognition target.

10. A non-transitory computer-readable medium storing an image processing program for causing a computer to perform an image recognition process using teacher data of a recognition target, the process comprising:
designating a mask designation area which is at least a part of a portion other than a specific characteristic portion in an image of the teacher data of the recognition target; and
generating masked teacher data by masking the designated mask designation area of the teacher data of the recognition target.

11. A deep learning image processing apparatus that performs image recognition using training data including a plurality of training images of a recognition target, the deep learning image processing apparatus comprising:
a memory storing the plurality of training images, and
a processor coupled to the memory and configured to execute a process including
generating, using the training images, masked training images by masking, within the training images, a mask designation area which is at least a part of a portion other than a specific characteristic portion of the recognition target;
performing deep learning using the masked training images; and
performing inference using a learnt weight generated in the performing deep learning.

12. The deep learning image process apparatus according to claim 1, wherein the mask designation area is determined based on a user input.

13. The deep learning image process apparatus according to claim 1, wherein the mask designation area is determined based on a semantic segmentation of the training images.
